(19) United States
(12) Patent Application Publication
(10) Pub. No.: US 2007/0058144 A1
(43) Pub. Date: Mar. 15, 2007

(54) Olfactory advertising system combined with image display device

(76) Inventors: Gordon Olsen, Las Vegas, NV (US); Pat Harrison, El Cajon, CA (US); Kris Vinkovic, Eagle Rock, CA (US)

Correspondence Address: PARK LAW FIRM, 3255 WILSHIRE BLVD, SUITE 1110, LOS ANGELES, CA, 90010, US

(21) Appl. No.: 11/225,621

(22) Filed: Sep. 12, 2005

(51) Int. Cl. G03B 21/00

(52) U.S. Cl. 353/122

(57) ABSTRACT

An olfactory advertising system combined with image display device includes a case, a luminous source image display displaying a first image, a focusing element receiving light from the source image display and focusing the light to form a second image that is viewable through the opening of the case, an interactive devices for controlling the behavior of the system, and a scent generating device. The scent generating device releases a predetermined scent according to the electronic signal from the interactive devices. The focusing element includes a concave mirror with a black coating on the reflecting surface. The scent generating device comprises a sensor system, and the sensor system detects a motion in a sensitive space in the opening of the case in front of the focusing element and produces an electronic signal.

### BACKGROUND OF THE INVENTION

The present invention relates to an olfactory advertising system for an image display device. More particularly, this invention relates to an olfactory advertising system for an image display device, in which a sensor system detects a motion in a given space. Also, this invention is related to an olfactory advertising system for an image display device, in which the behavior of the system is controlled by the information collected by the sensor system.

An image display device for three-dimensional imagery has been disclosed by the applicant's U.S. patent application Ser. No. 10/775,636. It includes a case, a luminous source image, and a focusing element. And, the focusing element is for receiving light from the source image display and focusing the light to form a second image that is viewable through the opening of the case, and includes a concave mirror and a mirror supporter.

If there are ways to control the behavior of the image display system, they will be useful for many purposes. Considering more vividness of the simulated three-dimensional image, the applications are really promising.

To control the behavior of the three-dimensional image, some interactive devices are needed. The interactive control system needs to detect a motion, or get an information, that will be interpreted as the user's intention on the operation of the system. The obtained information is used to change the text or image displayed on the image display device, prompting further interactions between the system and the user. The interactions can be applied to many types of commercial activities.

Accordingly, a need for an interactive control system for an image display device has been present from the invention of the image display device. This invention is directed to solve these problems and satisfy the long-felt need.

### SUMMARY OF THE INVENTION

The present invention provides an improved construction for an image display device that employs a concave mirror to provide simulated three-dimensional image.

An objective of the invention is to provide interactive devices that interacts with the image display device and controls the behavior of the image display device.

Another objective of the invention is to provide an interactive device that provides means to control the optical, chemical, mechanical behavior of the system.

Still another objective of the invention is to provide an interactive device that release scents corresponding to the displayed contents on the image display device.

To achieve the above objectives, an olfactory advertising system combined with image display device includes a case with an opening, a luminous source image display displaying a first image, a focusing element, interactive devices, and a scent generating device.

The scent generating device releases a predetermined scent according to the electronic signal from the interactive devices.

The luminous source image display displays a first image and is positioned within the case. The focusing element receives light from the source image display and focuses the light to form a second image that is viewable through the opening of the case. The focusing element is also positioned within the case.

The focusing element includes a concave mirror with a black coating on the reflecting surface.

The scent generating device includes a sensor system, and the sensor system detects a motion in a sensitive space in the opening of the case in front of the focusing element and produces an electronic signal.

The scent generating device includes a container containing chemicals, a release device installed at the container, and a control device for controlling the release device.

In an embodiment, the scent generating device includes a canister having a nozzle, a valve installed at the nozzle of the canister, a fan for blowing the scent released from the canister, and a control circuit for selecting the valve to open. The control circuit receives the electronic signal from the interactive devices. The release of the scent is controlled according to the user input.

The opening of the case is adapted to form a confinement in front of the concave mirror to have the released scent linger inside.

The fan of the scent generating device operates right after the scent is released in order to diffuse the scent inside the confinement. The fan of the scent generating device operates to blow the scent off the confinement. he operation of the fan is controlled by the control circuit.

The sensor system detects three-dimensionally a location and motion of a given object in a sensitive space in the opening of the case in front of the focusing element.

The sensor system detects a presence of an object in a sensitive space in the opening of the case in front of the focusing element. The sensor system detects the object by sensing electromagnetic wave of visible light or infrared frequency range.

The sensor system detects a location and motion on a two-dimensional plane perpendicular to the line of view in the opening of the case in front of the focusing element.

The scent generating device diffuses a chemical or combination of chemicals according to the contents displayed on the image display device.

The chemicals comprise a plurality of scents of foods, confectioneries, beverages, and aromatic materials.

The interactive devices further includes a printing device and a commodity dispensing device.

The olfactory advertising system accepts inputs from the interactive devices, and controls the outputs from the image display device, the scent generating device, and the commodity dispensing device.

The printing device is adapted to print out a commercial information on a media. The commercial information on a media comprises a point of purchase coupon.

The commodity dispensing device includes an electro-mechanical dispensing device adapted to dispense beverages, snacks, or perfumes.

The olfactory advertising system further includes an interface to the image display device, an information processing device, a communication network, and an information media accepting device.

The information processing device controls the behavior of the image display device through the interface to the image display device.

The information processing device exchange information with the communication network, which can be used to gather data that will be submitted to the advertiser so that he can view buyer's habits, build a consumer list, etc. The communication network comprises an internet or an intranet.

The information media accepting device is adapted to take in information stored on a predetermined media.

The advantages of the present invention are: (1) a simulated three-dimensional image display combined with a scent system which interacts with the image display device is provided; (2) the interactive device detects two or three-dimensional motion of a user mechanically or optically; (3) the system interacts with the user and produces scents related to what is displayed on the image display device.

Although the present invention is briefly summarized, the fuller understanding of the invention can be obtained by the following drawings, detailed description and appended claims.

### DESCRIPTION OF THE FIGURES

The applicant's U.S. patent application Ser. No. 10/775,636 is incorporated by reference into this disclosure as if fully set forth herein.

These and other features, aspects and advantages of the present invention will become better understood with reference to the accompanying drawings, wherein:

FIG. 1 is a perspective view of an image display system according to the present invention;

FIG. 2 is a front elevation view of the image display system;

FIG. 3 is a cross-section view of the image display device taken along the line II-II in FIG. 1;

FIG. 4 is a block diagram describing interactive devices of the present invention;

FIG. 5 is a plan view of a scent generating device with two canisters; and

FIG. 6 is a schematic circuit diagram of motion detector used for the scent system.

### DETAILED DESCRIPTION OF THE INVENTION

The applicant's U.S. patent application Ser. No. 10/775,636 filed on Feb. 10, 2004 is incorporated by reference into this disclosure as if fully set forth herein.

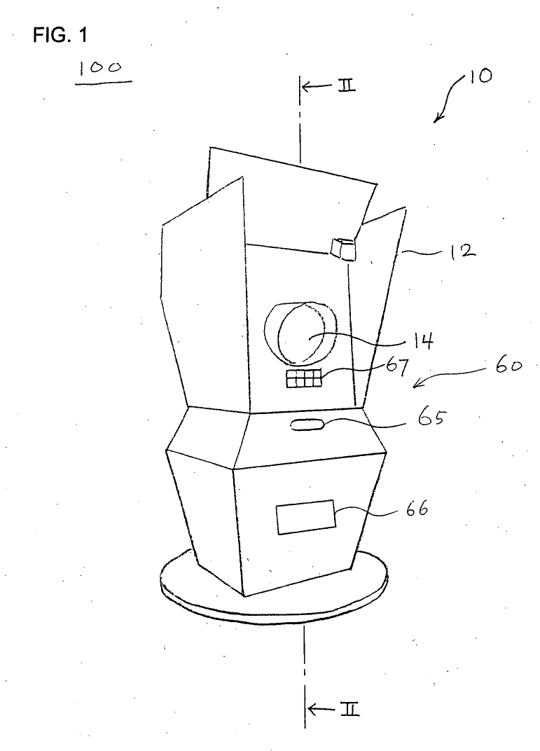

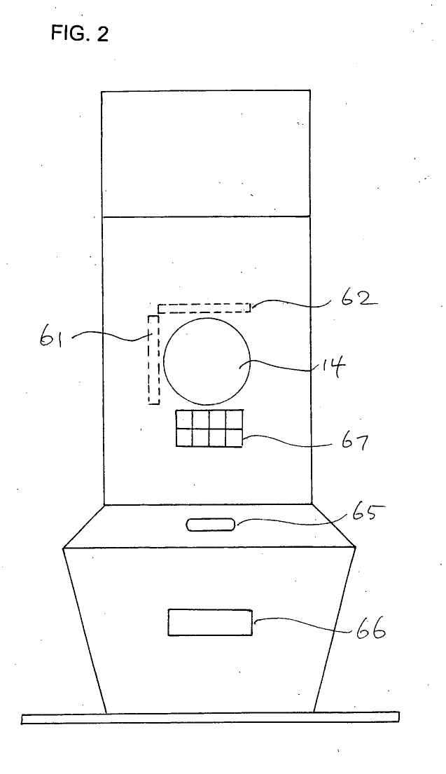

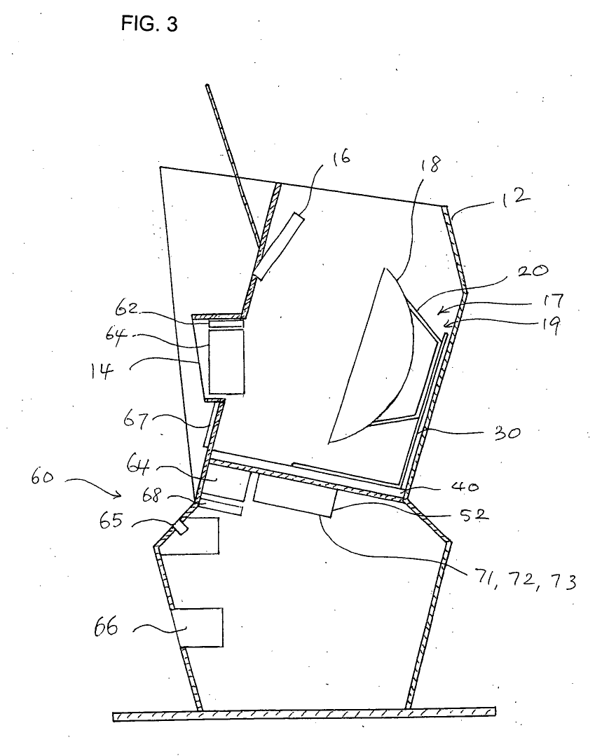

FIGS. 1 through 3 show an interactive control system 100 for an image display device 10 according to the invention.

The invention is mainly related to an interactive control system 100 in which a sensor system 61, 62 senses the motion of a user, interprets it for the intention of the user, and triggers events in response to the user's intention. Especially, the interactive control system 100 is incorporated to the image display device 10 and makes the most of the simulated three-dimensional image.

The interactive control system 100 for the image display device 10 includes a case 12, a luminous source 16, a focusing element 18, and an interactive device 60. The luminous source 16 receives the information on the image from the image source 52. It is the image source 52 that interacts with the image display device 10 and controls the image and the text displayed on the image display device 10.

The case 12 has an opening 14. The luminous source image display 16 displays a first image and the source image display 16 is positioned within the case 12. The focusing element 18 receives light from the source image display 16 and focuses the light to form a second image that is viewable through the opening 14 of the case 12 and the focusing element 18 is positioned within the case 12. The interactive device 60 controls the behavior of the system 10 in response of input from a user.

The interactive device 60 includes a sensor system 61, 62, and the sensor system 61, 62 detects a motion in a space 63 in the opening 14 of the case 12 in front of the focusing element 18. For example, the user puts in her/his hand into the opening 14 of the case 12 toward the displayed image to trigger the sensor system 61, 62 and then the interactive device 60. The sensor system 61 detects the vertical position of the motion of the user's hand and the sensor system 62 detects the horizontal position of the motion of the user's hand. The two-dimensional sensing of the motion of the user's hand can be obtained by combining two separate detections of horizontal and vertical positions, that is x and y coordinates of the motion. The detection of the depth of the motion can be accomplished by the supplemental information from either the vertical sensor system 61 or the horizontal sensor system 62, which extends in the direction of depth.

The focusing element 18 includes a concave mirror with a black coating on the reflecting surface, which endows the impression of the simulated three-dimension to the displayed image as if the image floats in the air.

The sensor system 61, 62 detects three-dimensionally a location and motion of a given object in the space 63 in the opening 14 of the case 12 in front of the focusing element 18. The sensor system 61, 62 detects a presence of an object in the space 63 in the opening 14 of the case 12 in front of the focusing element 18. The sensor system 61, 62 detects the object by sensing electromagnetic wave of visible light or infrared frequency range.

In a simpler embodiment, as discussed in the above, the sensor system 61, 62 is able to detect a location and motion on a two-dimensional plane perpendicular to the line of view in the opening 14 of the case 12 in front of the focusing element 18.

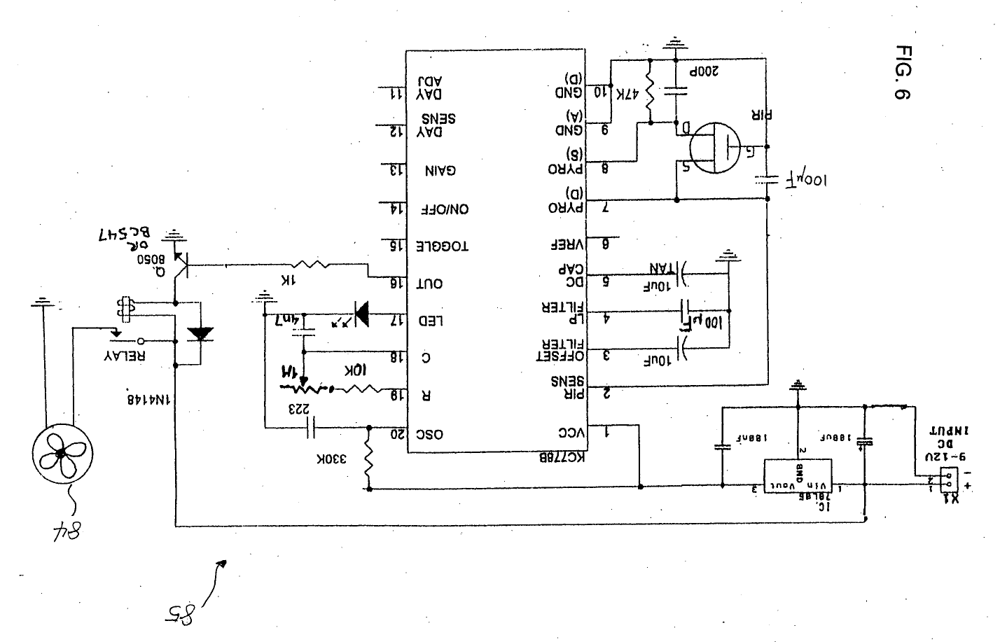

In a still simpler embodiment, the sensor system 61, 62 is replaced with a detector for detecting the presence or absence of an object like the user's hand using a simple circuitry as shown in FIG. 6.

The interactive devices 60 interact with the image display device 10. The interactive device 60 includes a chemical diffusing device 64. The chemical diffusing device 64 diffuses a predetermined chemical according to the contents displayed on the focusing element 18 of the image display device 10. The chemicals include a plurality of scents of foods, confectioneries, beverages, and aromatic materials. When the image display device 10 displays a candy, the chemical diffusing device 64 is triggered to release the scent of candy, which might be able to stimulate the user positively for the sake of advertisement.

The interactive device 60 includes a printing device 65, which is adapted to print out a commercial information on a media such as a piece of paper or a plastic card. The commercial information on the media includes a point of purchase coupon. If the candy is what she/he wants, the user pushes a hand into the opening to initiate the printing device 65 to print out a coupon for the candy.

The interactive device 60 includes a commodity dispensing device 66. The commodity dispensing device includes an electromechanical dispensing device adapted to dispense beverages, snacks, or perfumes. The image display device 10 is such an excellent advertisement that the user may purchase the item right away. The commodity dispensing device 66 can be controlled again by the sensor system 61, 62.

The interactive device 60 may include all of the chemical diffusing device 64, the printing device 65, and the commodity dispensing device 66. The control system 100 accepts inputs from the interactive devices 60, and controls the outputs from the image display device 10, the touch interface device 67, the chemical diffusing device 64, and the commodity dispensing device 66. The chemical diffusing device 64 diffuses a predetermined chemical according to the contents displayed on the image display device 10. The chemicals include a plurality of scents of foods, confectioneries, beverages, and aromatic materials. The printing device 65 is adapted to print out a commercial information on a media. The commercial information on a media includes a point of purchase coupon.

The commodity dispensing device 66 includes a electro-mechanical dispensing device adapted to dispense beverages, snacks, perfumes, or other items.

Therefore, the user gets a simulated three-dimensional visual information from the image display device 10, scent information from the chemical diffusing device 64, and then can obtain a coupon from the printing device 65 or purchase the item right away from the commodity dispensing device 66.

The interactive control system 100 further includes an interface 71 to the image display device 10, an information processing device 72, a communication network 73, and an information media accepting device 68. The interface 71 to the image display device 10, an information processing device 72, and a communication network 73 may be built in the image source 52.

The information processing device 72 controls the behavior of the image display device 10 through the interface 71 to the image display device 10. The image display device 10 communicates with the image source 52 through the interface 71.

The information processing device 72 exchange information with the communication network 73, which can be used to gather data that will be submitted to the advertiser so that he can view buyer's habits, build a consumer list, etc. The communication network 73 includes an internet or an intranet.

The information processing device 72 may be incorporated with the image source. In an embodiment, the image source 52 can be a regular notebook computer with the interface 71 to the image display device 10, information processing device 72, and communication network device 73, preferably a wireless internet device, in it.

The information media accepting device 68 is adapted to take in information stored on a predetermined media. The information media accepting device 68 is adapted for a credit card or a debit card. If the information media is a credit card, a verification of the credit information of the user is necessary, which can be done with the internet connection through the communication network 73.

The sensor system 61, 62 may include a touch pad or a touch screen 67, which is connected to the image source 52 and the information from which is processed by the information processing device 72 in image source 52. The touch pad or screen 67 might be adapted to deal with simpler items while the full vertical and horizontal sensor system 61, 62 are for more complicated items or situations.

The sensor system 61, 62 communicates data with the source image display 52. The interactive source image display 52 includes an interface 71 to the sensor system 61, 62 and an information processing device 72 for manipulating the information from the sensor system 61, 62. The information processing unit 72 displays information in text or image interactively according to the information provided by the sensor system 61, 62.

In another embodiment, the chemical diffusing device 64 includes a scent generating device.

The scent generating device 64 includes a sensor system 60, and the sensor system 60 detects a motion in a space 63 in the opening 14 of the case 12 in front of the focusing element 18 and produces an electronic signal.

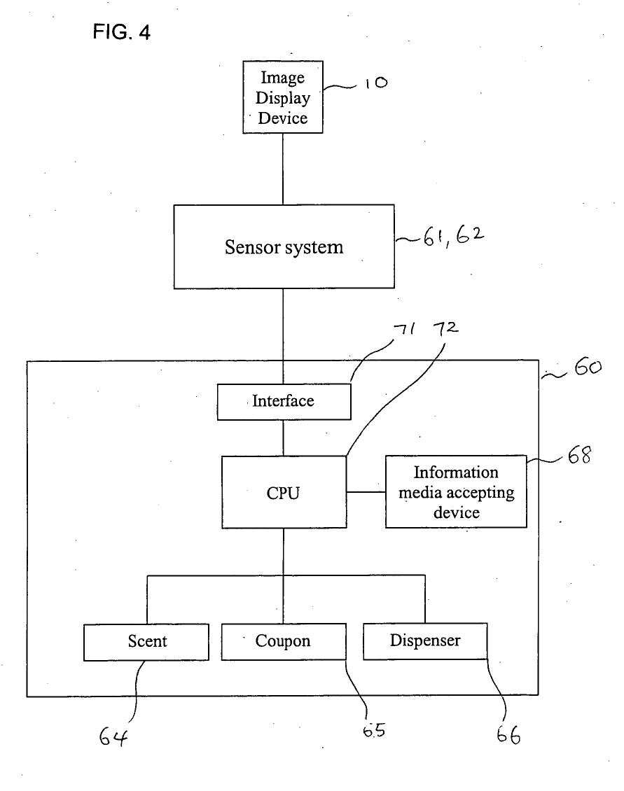

The interactive control system 100 is represented by the block diagram in FIG. 4.

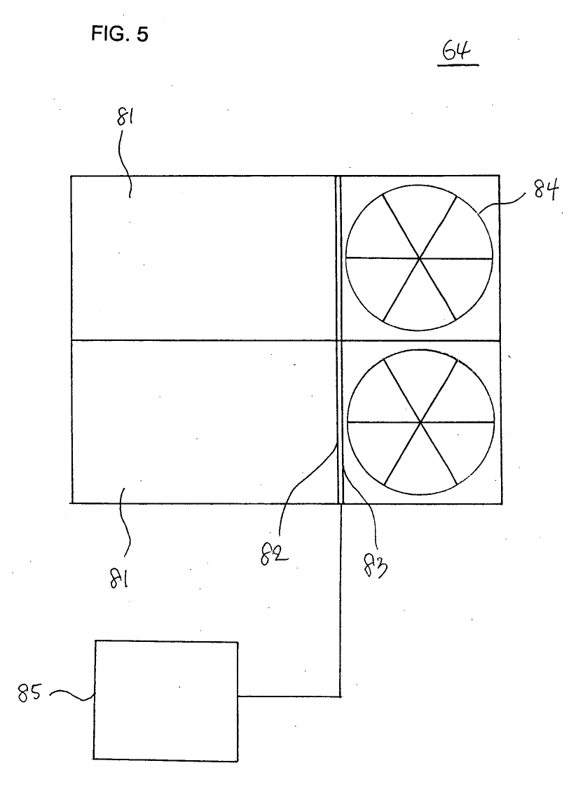

The scent generating device 64 includes a container 81 containing chemicals, a release device 83 installed at the container, and a control device 85 for controlling the release device as shown in FIG. 5.

In still another embodiment, the scent generating device 64 includes a canister 81 having a nozzle 82, a valve 83 installed at the nozzle 82 of the canister 81, a fan 84 for blowing the scent released from the canister 81, and a control circuit 85 for selecting the valve 83 to open. The control circuit 85 receives the electronic signal from the interactive devices of the system. The release of the scent is controlled according to the user input.

The opening 14 of the case 12 is adapted to form a confinement in front of the concave mirror 18 to have the released scent linger inside for a while. Preferably the confinement is coincided with the space 63 in which the movement of the user's hand was detected.

The fan 84 of the scent generating device 64 operates right after the scent is released in order to diffuse the scent inside the confinement 63. The fan 84 of the scent generating device 64 operates to blow the scent off the confinement 63. The operation of the fan 84 is controlled by the control circuit 85.

The scent generating device 64 and its connection to the sensor system are shown in FIGS. 5 and 6. A schematic circuit diagram of a pyroelectric sensor module is shown in FIG. 6. The sensor module is commercially available as KC7783 PIR detector module using an analog IC KC778B.

The sensor system 61, 62 detects three-dimensionally a location and motion of a given object in the space 63 in the opening 14 of the case 12 in front of the focusing element 18.

The sensor system 61, 62 detects a presence of an object in the space 63 in the opening 14 of the case 12 in front of the focusing element 18. The sensor system 61, 62 detects the object by sensing electromagnetic wave in visible light or infrared frequency range.

The sensor system 61, 62 detects a location and motion on a two-dimensional plane perpendicular to the line of view in the opening 14 of the case 12 in front of the focusing element 18.

The scent generating device 64 diffuses a chemical or combination of chemicals according to the contents displayed on the image display device 10.

The chemicals include a plurality of scents of foods, confectioneries, beverages, and aromatic materials.

The interactive devices further include a printing device 65 and a commodity dispensing device 66.

The olfactory advertising system 100 accepts inputs from the interactive devices, and controls the outputs from the image display device 10, the scent generating device 64, and the commodity dispensing device 66.

The printing device 65 is adapted to print out a commercial information on a media. The commercial information on a media includes a point of purchase coupon.

The commodity dispensing device 66 includes an electro-mechanical dispensing device adapted to dispense beverages, snacks, and perfumes.

The interactive control system 100 may work as an olfactory advertising system, which further includes an interface 71 to the image display device 10, an information processing device 72, a communication network 73, and an information media accepting device 68.

The information processing device 72 controls the behavior of the image display device 10 through the interface 71 to the image display device 10.

The information processing device 72 exchange information with the communication network 73. The communication network 73 comprises an internet or an intranet.

The information media accepting device 68 is adapted to take in information stored on a predetermined media.

More specifically, the sensor system 61, 62 communicates data with the image source 52. In another embodiment, the image source 52 may include an interface 71 to the sensor system 61, 62 and an information processing device 72 for manipulating the information from the sensor system 61, 62.

The information processing device 72 displays information in text or image interactively according to the information provided by the sensor system.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An olfactory advertising system combined with image display device, comprising:
(a) a case comprising an opening;
(b) a luminous source image display displaying a first image, wherein the source image display is positioned within the case;
(c) a focusing element receiving light from the source image display and focusing the light to form a second image that is viewable through the opening of the case, wherein the focusing element is positioned within the case;
(d) an interactive devices for controlling the behavior of the system; and
(e) a scent generating device,
wherein the scent generating device releases a predetermined scent according to the electronic signal from the interactive devices.

2. The olfactory advertising system of claim 1, wherein the focusing element comprises a concave mirror with a black coating on the reflecting surface.

3. The olfactory advertising system of claim 1, wherein the scent generating device comprises a sensor system, wherein the sensor system detects a motion in a sensitive space in the opening of the case in front of the focusing element and produces an electronic signal.

4. The olfactory advertising system of claim 1, wherein the scent generating device comprises:
(a) a container containing chemicals;
(b) a release device installed at the container; and
(c) a control device for controlling the release device.

5. The olfactory advertising system of claim 4, wherein the scent generating device comprises:
(a) a canister having a nozzle;
(b) a valve installed at the nozzle of the canister;
(c) a fan for blowing the scent released from the canister; and
(d) a control circuit for selecting the valve to open.

6. The olfactory advertising system of claim 5, wherein the control circuit receives the electronic signal from the interactive devices.

7. The olfactory advertising system of claim 5, wherein the release of the scent is controlled according to the user input.

8. The olfactory advertising system of claim 7, wherein the opening of the case is adapted to form a confinement in front of the concave mirror to have the released scent linger inside.

9. The olfactory advertising system of claim 8, wherein the fan of the scent generating device operates right after the scent is released in order to diffuse the scent inside the confinement.

10. The olfactory advertising system of claim 8, wherein the fan of the scent generating device operates to blow the scent off the confinement.

11. The olfactory advertising system of claim 8, wherein the operation of the fan is controlled by the control circuit.

12. The olfactory advertising system of claim 5, wherein the sensor system detects three-dimensionally a location and motion of a given object in a sensitive space in the opening of the case in front of the focusing element.

13. The olfactory advertising system of claim 5, wherein the sensor system detects a presence of an object in a sensitive space in the opening of the case in front of the focusing element.

14. The olfactory advertising system of claim 13, wherein the sensor system detects the object by sensing electromagnetic wave of visible light or infrared frequency range.

15. The olfactory advertising system of claim 5, wherein the sensor system detects a location and motion on a two-dimensional plane perpendicular to the line of view in the opening of the case in front of the focusing element.

16. The olfactory advertising system of claim 5, wherein the scent generating device diffuses a chemical or combination of chemicals according to the contents displayed on the image display device.

17. The olfactory advertising system of claim 16, wherein the chemicals comprise a plurality of scents of foods, confectionaries, beverages, and aromatic materials.

18. The olfactory advertising system of claim 5, wherein the interactive devices further comprise:
a) a printing device; and
b) a commodity dispensing device,
wherein the olfactory advertising system accepts inputs from the interactive devices, and controls the outputs from the image display device, the scent generating device, and the commodity dispensing device.

19. The olfactory advertising system of claim 18, wherein the printing device is adapted to print out a commercial information on a media.

20. The olfactory advertising system of claim 19, wherein the commercial information on a media comprises a point of purchase coupon.

21. The olfactory advertising system of claim 18, wherein the commodity dispensing device comprises an electro-mechanical dispensing device adapted to dispense beverages, snacks, or perfumes.

22. The olfactory advertising system of claim 1, further comprising:
a) an interface to the image display device;
b) an information processing device;
c) a communication network; and
d) an information media accepting device.

23. The olfactory advertising system of claim 22, wherein the information processing device controls the behavior of the image display device through the interface to the image display device.

24. The olfactory advertising system of claim 22, wherein the information processing device exchange information with the communication network.

25. The olfactory advertising system of claim 24, wherein the communication network comprises an internet or an intranet.

26. The olfactory advertising system of claim 22, wherein the information media accepting device is adapted to take in information stored on a predetermined media.

27. The interactive control system of claim 22, wherein the information processing device is adapted to gather and analyze buyer's habits and to build a consumer list.
